(19) United States
(12) Patent Application Publication
(10) Pub. No.: US 2006/0287878 A1
(43) Pub. Date: Dec. 21, 2006

(54) System and Method for Facilitating the Introduction of Compatible Individuals

(75) Inventors: Suneet Wadhwa, San Francisco, CA (US); Andrew Pickholtz, San Francisco, CA (US); Karen Wallace, Berkeley, CA (US)

Correspondence Address: NOVAK DRUCE DELUCA & QUIGG, LLP, 1300 EYE STREET NW, SUITE 400 EAST TOWER, WASHINGTON, DC, 20005, US

(73) Assignee: Engage Corporation, Oakland, CA (US)

(21) Appl. No.: 11/425,390

(22) Filed: Jun. 20, 2006

Related U.S. Application Data
(60) Provisional application No. 60/595,282, filed on Jun. 20, 2005.

(51) Int. Cl. G06Q 99/00; G07G 1/00; G06F 17/30

(52) U.S. Cl. 705/1; 705/10

(57) ABSTRACT

A system and method for facilitating an online collaborative community for individuals to meet each other with the assistance of third party intermediaries or matchmakers. The system provides the intermediaries with a variety of features to participate and collaborate in the process of identifying potentially compatible individuals and arranging for the introduction of those individuals. For example, the intermediaries can provide profile information about individual participants, search for potentially compatible individuals for others, or introduce individuals to each other. The introductions can be of individuals who are already participating or who are subsequently invited to participate. Introductions may also be anonymous. Other features include a rating or ranking of intermediaries based on the quality of their introductions, a polling feature whereby users are asked to vote on potential matches for certain participants, and a real time event feature whereby participants may chat, research information on other participants, and identify potential participants for introduction. Still other features of the system are described herein.

### CROSS-REFERENCE TO RELATED APPLICATION

This application claims the benefit of and priority to U.S. Provisional Patent Application No. 60/595,282, filed Jun. 20, 2005 and entitled “System and Method for Facilitating Matching of Compatible Individuals”, which application is hereby incorporated by reference, under 35 U.S.C. § 119(e).

### BACKGROUND OF THE INVENTION

1. Field of the Invention

The invention generally relates to the field of computerized methods of and systems for matching compatible individuals for romantic and other social, cultural, special interest and/or business purposes. The invention also relates generally to the field of computerized methods of and systems for organizing networks of individuals in online communities for social or professional purposes. More particularly, the invention relates to methods and systems for enabling the involvement of third party intermediaries or matchmakers in the processes of identifying potentially compatible individuals and arranging for the introduction of those individuals to each other. The invention facilitates the collaboration of third parties in the identification of potentially compatible individuals and the introduction of people by people.

2. Related Art

Currently, a variety of services are commercially available to assist an individual in finding a suitable match for companionship or other purposes. Such services include proprietary databases for use by professional matchmakers, membership-based online dating services, and online social networking services.

Professional matchmakers and matchmaking services typically interview new clients to gather information about the clients that will be useful in the matchmaking process. The profile information usually includes such characteristics as a client's age, height, weight, religion, educational level, profession, income, and hobbies. In addition, clients often provide a photograph or video of themselves. At the same time, the client specifies the characteristics they desire in a mate. For example, the client might identify an age range, and acceptable religions and ethnicities, among other things, for what they consider to be a suitable mate or partner.

For years, professional matchmakers and matchmaking services have relied on proprietary computerized databases to store the data provided by and about their clients. The matchmaker could then search their databases to identify suitable matching clients to introduce to each other. Additionally, computerized matching algorithms could assist the matchmakers identify suitable matches.

With the advent of widespread availability and use of the World Wide Web (“Web”) on the Internet during the 1990s, a new type of computerized dating service gained in popularity. Indeed, these online dating sites are still gaining in popularity. Examples of such sites are the current versions of www.match.com, www.matchmaker.com and Yahoo! Personals. Online dating sites allow users themselves to enter their own personal information into the site's database. The sites usually also allow users to upload one or more photos and sometimes video or audio of the user. The user providing this information then becomes a member of the site, sometimes paying a fee for certain services and sometimes not, depending on the service and any promotions being run by the site at that time.

When other users or guests visit the member-based dating Web site, the user or guest can typically search the database of existing members based on desirable personal characteristics. Such characteristics include age range, geographic location, religion, etc. If a search reveals a suitable individual, the user or guest can contact the member via electronic mail (“e-mail”) to arrange a conversation or meeting.

Some member-based dating Web sites include computerized recommendation engines that rely on mathematical algorithms to assist in the selection of suitably compatible matches. Web sites that use more sophisticated algorithms for such purposes often request additional information of the members, such as asking the members to answer questions that are expected to be revealing of the member's personality. An example of such a Web site is the current version of www.eharmony.com.

Another type of Web site that has somewhat different objectives and operation than an online dating service is an online social networking service. Online social networking services permit members to build groups of other members into networks of friends or associates. Each member can invite other people to participate on the service in the member's network. Depending on the service, a member can look at, search for and contact members that they invited, and members who were directly or indirectly invited by their invitees. Sometimes the purpose of the network is explicitly stated and invitations are oriented towards that purpose. For example, the current version of www.linkedin.com states that the networks can be useful for finding clients, sales leads, jobs and services. The current version of www.friendster.com states that the network is useful to stay connected with friends.

Existing matchmaking services have numerous shortcomings. Proprietary databases used by professional matchmakers do not benefit from the interactive nature of self-service Web applications or their efficiencies. Potential daters have to rely exclusively on the judgment of a single or small number of matchmakers to cull through the available matches.

Existing member-based dating Web sites have their own deficiencies. First, members, particularly attractive women, are often barraged by numerous requests for a conversation or date. Consequently, many requests to meet both promising and unlikely matches are often ignored. Second, the fact that many emails between members are unanswered results in a feeling of rejection or alienation for other members, particularly shy men. Third, members, especially women, are often fearful of conversing with or meeting other members they meet online since there is little or no way to know whether the other member can be trusted. Fourth, particularly because of the high rejection rate for inter-member communication, existing services tend to be isolating, resulting in a perceived social stigma for participants. Fifth, the high rejection rates and tendency towards individual isolation inherent in the services contribute to a higher rate of “churn.” Many members discontinue their membership with the services even before successfully finding a long-term romantic partner. Sixth, existing services do not cater to married users and others who enjoy assisting others with their love lives or watching and gossiping about other people's love lives. Seventh, existing services are not particularly fun to use.

Similarly, existing social networking sites are not well suited for meeting romantic companions. On these sites, a member's network only includes people the member knows directly or indirectly. This imposes an undesirable limitation on the number of persons the member might correspond with and meet for purposes of dating. This limitation undermines one of the advantages of self-service Web sites for dating: the potentially large population of possible suitors.

Another disadvantage of social networking sites for dating is that the purpose of the invitations may be only obliquely related to dating. Since the purpose of the network is for building a large community, e.g. of professional colleagues or friends, the concept of the network itself has limited added value for romantic purposes. Indeed, the network may be a disadvantage for daters, since, just as in the offline world, there are social and professional risks in asking existing friends and colleagues for a date, even if the friendship or professional relationship is indirect.

Another disadvantage of many existing social networking sites is that users are not usually willing to pay for the type of service that they provide. In particular, users are not generally interested in paying for friendship, tracking friends or voyeuristically looking at lists of friends of friends.

Consequently, what is needed is an online service that addresses the shortcomings of the existing member-based dating sites and social networking sites for purposes of dating and romance.

### SUMMARY OF THE INVENTION

The present invention provides a system and method for facilitating an online collaborative community for individuals to meet each other with the assistance of third party intermediaries or matchmakers. The system provides the intermediaries with a variety of features to participate and collaborate in the process of identifying potentially compatible individuals and arranging for the introduction of those individuals to each other. For example, the intermediaries can provide profile information about individual participants, search for potentially compatible individuals for others, or introduce individuals to each other. The intermediaries making the introductions may be professional matchmakers, amateur matchmakers, friends of participants, or casual users. The introductions can be of individuals who are already participating in the online community or who are subsequently invited to participate. Introductions may also be anonymous. Other features include a rating or ranking of intermediaries based on the quality of their past introductions, a polling feature whereby users are asked to vote on potential matches for certain participants, and a real time event feature whereby participants may chat, research information on other participants, and identify potential participants for introduction. Still other features of the system are described herein. By providing facilities to make it easy and fun to be a matchmaker, the system benefits daters and matchmakers alike.

### BRIEF DESCRIPTION OF THE DRAWINGS

The invention is described in detail with reference to the following figures, in which:

FIG. 1 shows a block diagram of a distributed communication network of a type that can be used to implement the concepts and features of the invention;

FIG. 2 shows a home page that can be used with the present invention;

FIG. 3 shows an alternate home page that can be used with the present invention;

FIG. 4 shows a sign-in Web page for existing members to logon to the system;

FIG. 5 shows a sign-up Web page for users to register with the system;

FIG. 6 shows a Web page for a new member to enter selected profile information;

FIG. 7 shows a Web page that allows a member to invite to join the service matchmakers and people for whom the member wants to act as matchmaker;

FIG. 8 shows a Web page allowing a member to seek advice from other members;

FIG. 9 shows a Web page allowing members to describe their interest in being a matchmaker;

FIG. 10 shows an example of a member's personal home page;

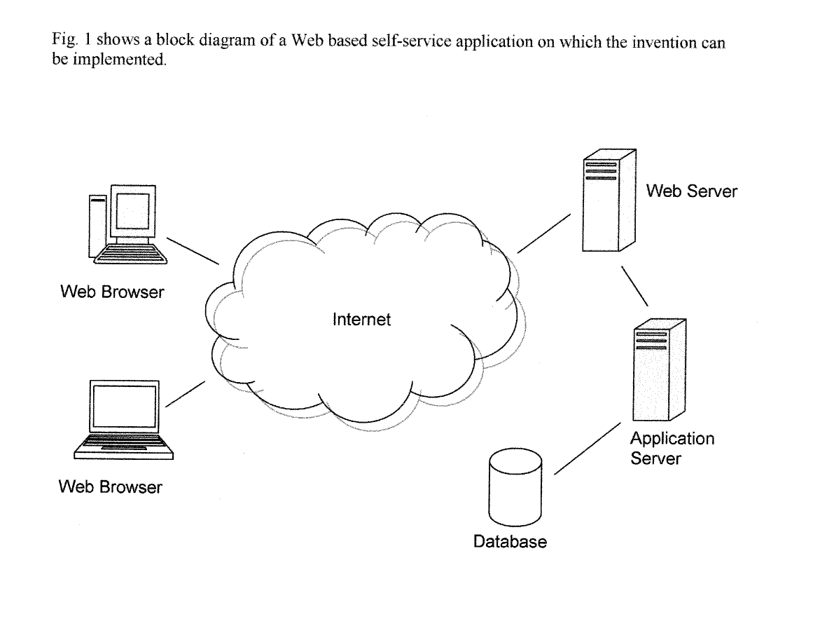

FIG. 1 shows an example of a member's community;

FIG. 12 shows a Web page that tracks the introductions made for a member;

FIG. 13 shows a Web page that tracks the introductions that a member has made;

FIG. 14 is a Web page showing dating/introduction prospects for a member;

FIG. 15 is a Web page showing the advice a member has received;

FIG. 16 shows a Web page that allows a member to change his or her profile information;

FIG. 17 shows a Web page that allows a prospect search to be made on behalf of a friend;

FIG. 18 shows a Web page displaying the results of searching on behalf of a friend;

FIG. 19 shows a Web page to permit a user to choose whom they would like to introduce;

FIG. 20 shows a Web page enabling a user to introduce someone to a member or to select someone to introduce to the member;

FIG. 21 shows a Web page enabling a user to introduce two members to each other;

FIG. 22 shows an alternate Web page that permits a user to select whom they would like to introduce by searching a database, selecting from the user's community, or entering an email address;

FIG. 23 shows a Web page providing a simplified description of one variation of how introductions work in accordance with one embodiment of the invention;

FIG. 24 shows a Web page that allows a user to request an introduction from a matchmaker;

FIG. 25 shows a Web page of an introduction intended to be viewed by the members being introduced;

FIG. 26 shows an upper portion of a Web page displaying a member's basic profile information, including the member's ratings as a community member and ratings as a matchmaker;

FIG. 27 shows a Web page allowing a member to request a friend to write a reference for a member;

FIG. 28 shows a portion of a Web page that permits a user to submit advice to a member;

FIG. 29 shows a Web page permitting a user to select the best match for a particular member from a plurality of choices and showing what other members thought regarding a previous vote of choices for another member;

FIG. 30 shows the top portion of a Web page that identifies top matchmakers;

FIG. 31 shows an alternate Web page displaying a portion of the profile for a member and the ability for the user to contribute to the profile;

FIG. 32 shows a Web page displaying a list of real-time online events for introducing individuals; and

FIG. 33 shows a Web page displaying the people who matched each other during a previously concluded online introduction event.

### DETAILED DESCRIPTION OF PREFERRED EMBODIMENTS

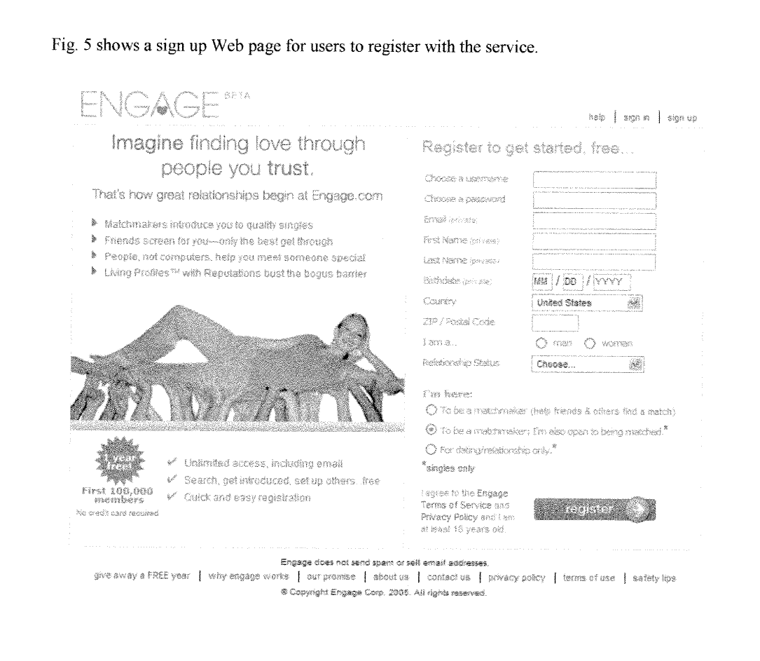

The system may and generally would include features typical of traditional membership-based dating services, e.g. a registration process and a method to search through the database for members meeting certain criteria (see FIGS. 5, 17). However, more importantly, the system includes a variety of novel features oriented to matchmaking and introductions that embody different aspects of the invention. The features can be included in the service either individually or collectively with one or more of the other features. The system can charge users to access some of the services on the system, but not others.

Intermediaries or Matchmakers.

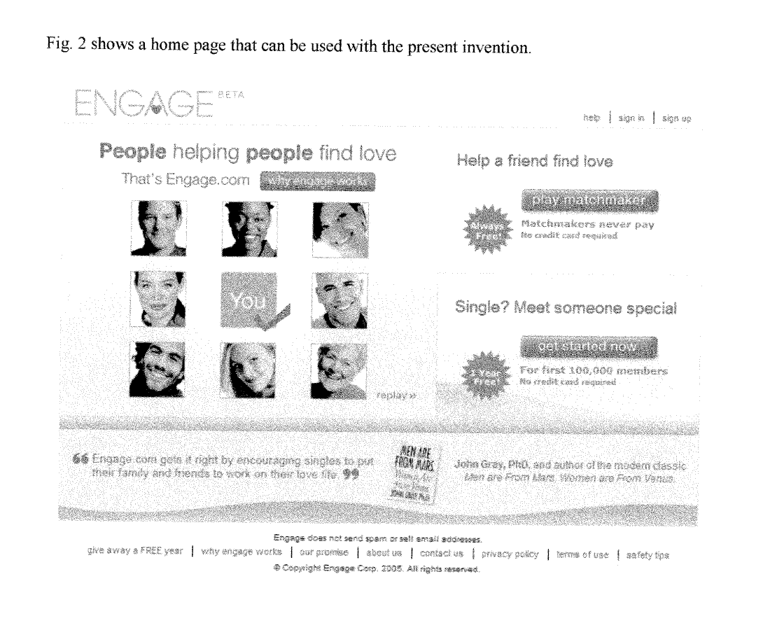

The service relies on the collaborative efforts of intermediaries or matchmakers to foment an online community with individuals seeking mates for romantic, business or other purposes (see FIG. 2). The service benefits from the fact that human beings have intuitions and insights that go well beyond computer generated algorithms.

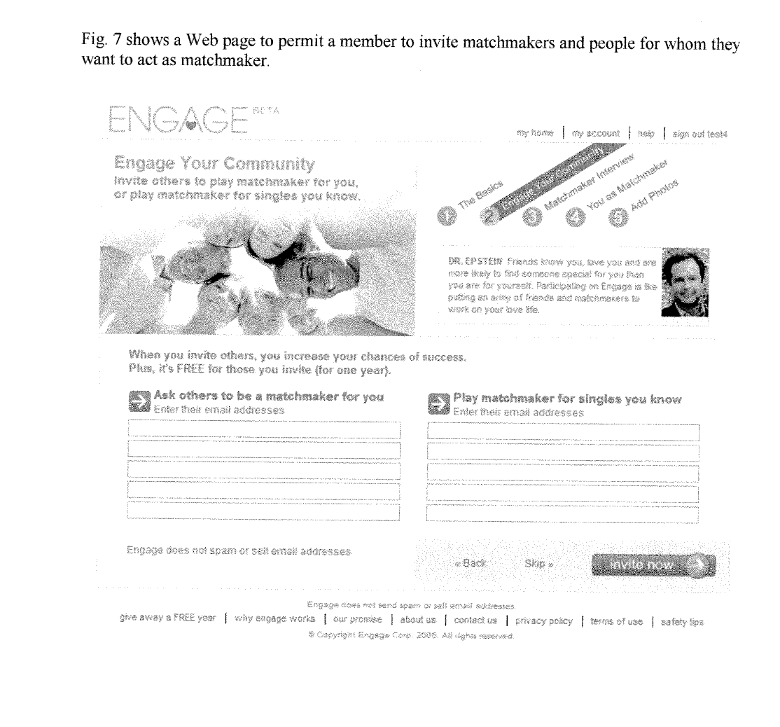

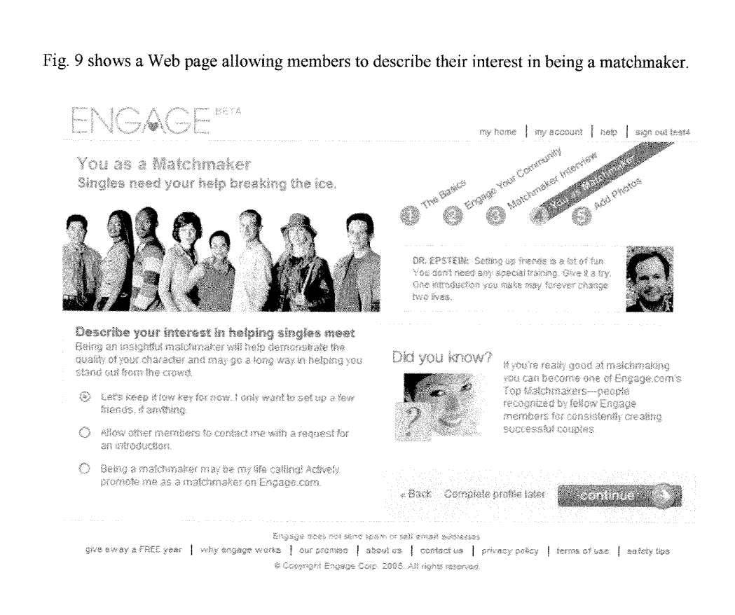

Members of the service can have matchmakers and can also be matchmakers. A member can have one or more matchmakers who are interested in introducing the member to potential mates. Similarly, a member can serve as a matchmaker for one or more other members. Matchmakers generally make introductions and are available to assist other members to meet new people (see FIGS. 7, 9, 19, 20, 21, 22, 23, 24, 25, 29). A user can communicate with another member's matchmaker, and vice-versa. So, a user may ask a matchmaker for an introduction to a particular member. In that case, a request for an introduction can be to the user's own matchmaker or the other member's matchmaker. A user can also ask a matchmaker whether a particular member seems suitable or can consult with their matchmaker for other general advice.

Although the system will typically permit all members to be matchmakers, in certain circumstances it may be desirable to limit the matchmaker functionality to a restricted group of users. So, for example, matchmakers could be required to go through a different and potentially more restrictive registration process than the one whose implementation is shown below.

Introductions.

Fundamental to the system is the notion that lasting relationships are more likely to be formed when people introduce people, as opposed to individuals directly seeking out other individuals, based on criteria such as photos, profiles, or automated algorithms (see FIG. 2).

Introductions can take many forms on the system. When making an introduction, a matchmaker can identify how well he or she knows each individual being introduced. In some cases, the matchmaker will know one or both of the individuals, in many cases not. The individuals being introduced may or may not already be members of the service. If they are not already members of the service, the service sends appropriate emails encouraging enrollment in the service. Another form of introduction is an anonymous introduction in which the people being introduced are not informed of the identity of the matchmaker.

The individuals getting introduced can receive electronic messages, e.g., e-mail, informing them via a link where they can look at the content of the introduction. Some or all of the content of the introduction can be incorporated in the email, requiring the people being introduced to use the systems' communications mechanisms to contact the other person being introduced. An introduction can be as simple as the identification information of the other party being introduced, or it may include text describing why the two parties should meet, an indication of how or for how long the intermediary knows each of the parties, or other data.

Matchmakers in the real world and in the inventive system benefit from making introductions in many ways, and the system provides mechanisms to further highlight these benefits. Matchmakers make introductions for many reasons in addition to altruism. First, matchmakers who make introductions will likely receive introductions from other members returning the favor. In this regard, the system provides a feature to remind a member who has received an introduction that a reciprocal introduction would be appropriate and another feature to facilitate the making of a reciprocal introduction. Second, matchmakers often receive gratitude and appreciation for making an introduction, and the system provides an easy mechanism for a member to send a “thank you” to a matchmaker. Third, a matchmaker who does a good job can receive recognition for a high quality introduction. This is achieved through a feature enabling a member to rate the quality of an introduction. Fourth, members can be ranked based on the ratings of their introductions. Consequently, matchmakers who do a good job can receive public recognition for their high ranking. Fifth, the system can reward matchmakers for making introductions with financial and other credits. Sixth, the system entertains many people's voyeuristic tendencies by letting the matchmaker know certain limited information about whether the introduced parties actually communicated and how many times they communicated.

Matchmaker Voting and Polls.

It should not be overlooked that playing matchmaker can also be just good plain fun. The system has several features that allow users of the system to have fun with matchmaking. One feature allows a user to make suggestions about whom a member should consider meeting (FIG. 29). A picture of the member is shown alongside a plurality of pictures of possibly suitable matches. The user then chooses which of the possible matches is most suitable for the member. There can be many variations of this feature. In one, the pictures of the members or possible matches are shown along with some profile information such as age and geographic location. In another variation, the user is asked to rank the possible matches, rather than just picking the most suitable. In another variation, the user is asked to rate the suitability of each of the possible matches on a scale of for example one to ten.

In this “voting” feature of the service, after a user selects a suitable match for a member or ranks or rates the possible matches for that member, the service can either notify the member of the suggestion or store the suggestion information for future processing. If the suggestion is stored for future processing, such information can be accumulated from a plurality of users. Once sufficient information is accumulated, for example after twenty users have evaluated the possible matches, a summary of the information or a selective report of the information can be provided to the member and/or the possible matches (FIGS. 14, 25). One possibility is that only the member and the possible match receiving the most votes receive an email informing them that they were chosen as the most suitable match.

The system can choose the member and the potential matches to be voted on in a variety of ways. For example, the member and the potential matches could be chosen randomly from all members on the service. However, it would be preferable for the system to choose potential matches with reasonably suitable profiles with respect to sexual preference, age, geographic location and/or religious preference, for example. Furthermore, although it would be possible for the system to dynamically select a member and a few potential matches for each user each time the user votes, given a potentially large number of potential members on the service, the best matches may then have to be derived statistically from the voting. A simpler mechanism would be to choose a subset of members on the service and for each member in the subset choose a few potential matches. The subset could be chosen randomly or with intervention by the system operator. Then, the voting feature would only display members to be voted on from the subset until sufficient information is accumulated for each member in the subset. At that point, a new subset is chosen for a new round of voting. If a member or his or her potential matches cancel their membership while the member is part of the subset being voted on, the member can be removed from the subset.

Collaborative Community of Matchmakers.

The matchmaker relationships on the system create a supportive community for the members. Each member in effect has a private community of people the member is willing to introduce and another community of people who will introduce the member. In some cases, two members will be mutual matchmakers for each other and hence included in both of each other's private communities.

Among other things, matchmakers can provide profile information about the individuals they are willing to introduce (see FIG. 31). So, a matchmaker might add an additional photograph of the individual, write additional descriptive information or add a descriptive “tag” or keyword.

One advantage of the system is that the relationships between members on the service are functional. Namely, there is an explicit productive reason why one member is included in another's community: so that one member can make future introductions between the other member and third parties.

The novel ways in which the system incorporates intermediaries and introductions provides many advantages in an online dating service. First, in some cultures, individuals, especially women, are taught not to talk with members of the opposite sex unless they are introduced. Even without this custom, there is often a stigma attached to communicating with people one does not know without an introduction. At a minimum, introductions provide a socially acceptable and comforting framework for two people to meet. Second, introductions serve as a filter to screen suitors and are a more efficient alternative to direct communication. Suitors who are particularly unsuited will have a more difficult time getting a favorable introduction from a third party, particularly a trusted third party, than they would by sending a blind email. Conversely, the involvement of a third party lowers the rejection rate for inter-member communications. Social etiquette requires that the parties being introduced respond with a polite email to the other individual being introduced, at a minimum. After all, the introducer has done the introduced individuals a favor which should not just be ignored.

Fourth, research suggests that friends and family are much more likely to find a better match for an individual than the individual himself or herself. Fifth, the involvement of a third party matchmaker such as a friend or family member will often contribute to a sense that one's community sanctions the meeting, which can be a good predictor of future success for the relationship. Sixth, introductions are advantageous because people enjoy being matchmakers and setting up other people to meet each other. Seventh, in many respects, people are better than computer algorithms at gauging individual compatibility. An algorithm can be used to narrow large numbers of potential dating candidates, but human matchmakers are still better at actually assessing mutual compatibility. Eighth, introductions provide virality for the system, that is, introductions used on the service introduce new individuals to the service. In this way, use of the service is its own marketing and promotion.

In short, the system's emphasis on a collaborative community of matchmakers and self-service online introductions provides many advantages over existing computerized dating systems. The introductions and a member's willingness to offer future additional introductions create matchmaker relationships between the members. This in turn provides a novel community based online matchmaking system.

Ratings and Rankings.

Another aspect of the service is that individuals are rated based on a variety of characteristics (see FIGS. 26, 30). For example, members who are interested in dating can be rated by other members on their responsiveness to communications, their level of kindness and whether they are true to their profile. Based on ratings by many other users, a member builds up a reputation that can serve, at least to some extent, as a basis for someone else to decide whether the member is trustworthy or reputable.

Members are also rated based on the introductions they make. Individuals who receive an introduction from a matchmaker can rate the quality of the introduction. Then other users can view an aggregated rating of the quality of the matchmaker's introductions and the quantity of introductions made. Other users will likely respect and wish to associate with matchmakers who make high quality introductions. The matchmakers, in turn, will want to protect and enhance their reputations. The rating of members, both generally and with respect to their matchmaking activities, is intended to increase the level of civility on the service and serve as an indicator, albeit imprecise, of the trustworthiness and reputation of the members.

It should be noted that the ratings that are displayed regarding a member may not be the strict average of the raw ratings provided by other users of the system. So, for example, different users will have different standards to decide when a member deserves four or five stars out of a five star scale. The grading curve for ratings can thus be adjusted to accommodate for individual differences in the ratings given by the users providing the data. Another reason for adjusting the ratings curve is to recognize the fact that some characteristics of a member are entirely acceptable and should be viewed as such even if users of the system are stingy with higher ratings.

The ratings of matchmakers can be used to rank the matchmakers. Consequently, users can be informed who the best matchmakers are and decide which matchmakers to seek out for dating advice and introductions. This ranking and rating system can create a marketplace for matchmakers. A matchmaker with a high rating may be able to charge a fee for his or her services and the system could in turn charge the matchmaker a fee for access to the service. Alternatively, the system could charge members fees for the services of the matchmakers and, in turn, pay the matchmakers a portion of the proceeds.

Invitations

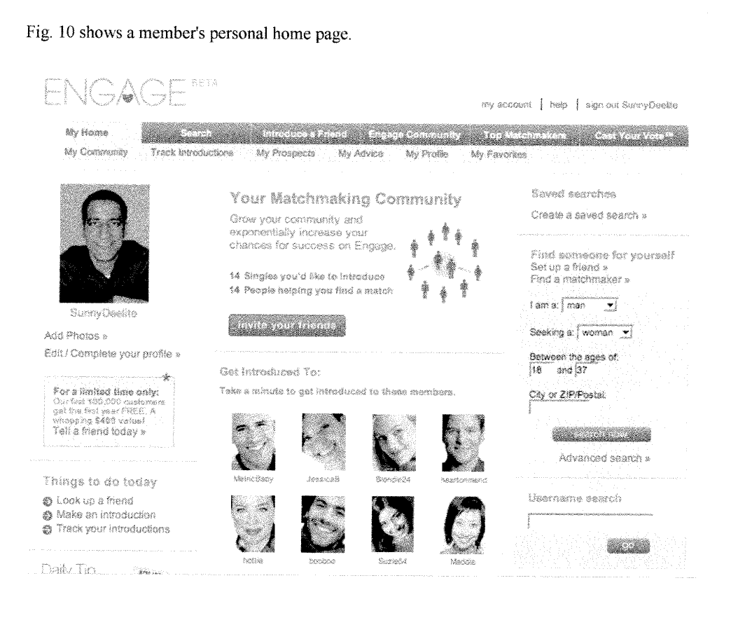

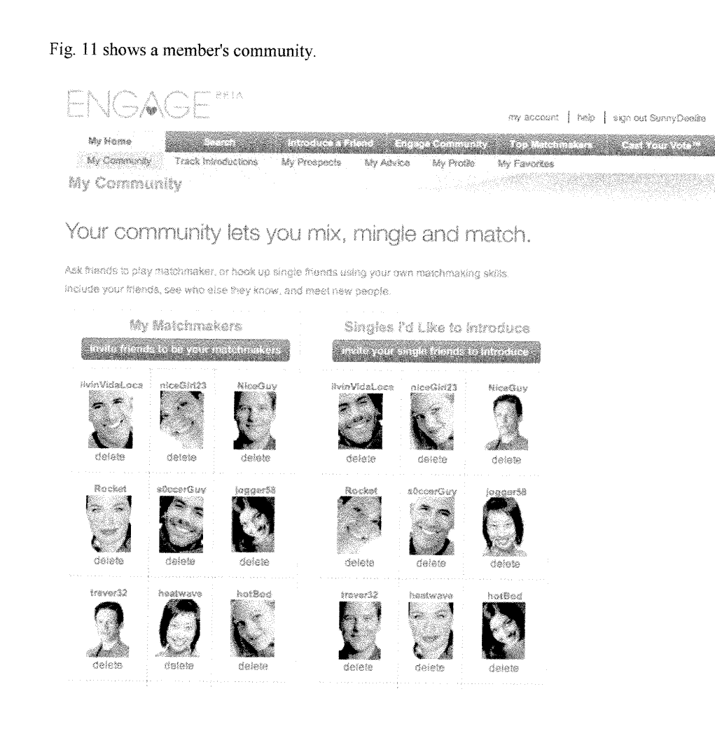

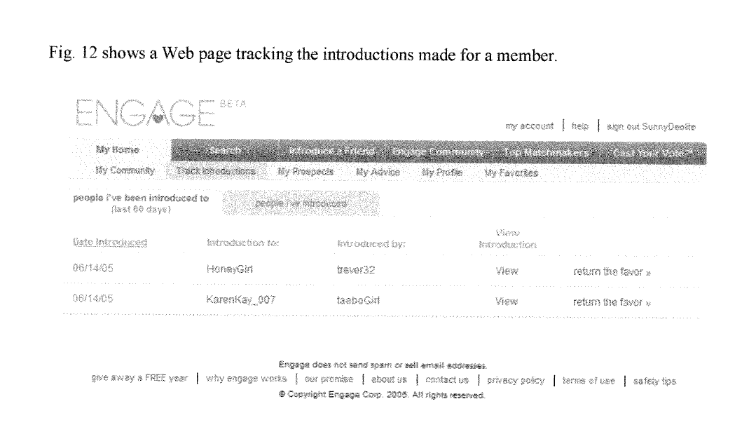

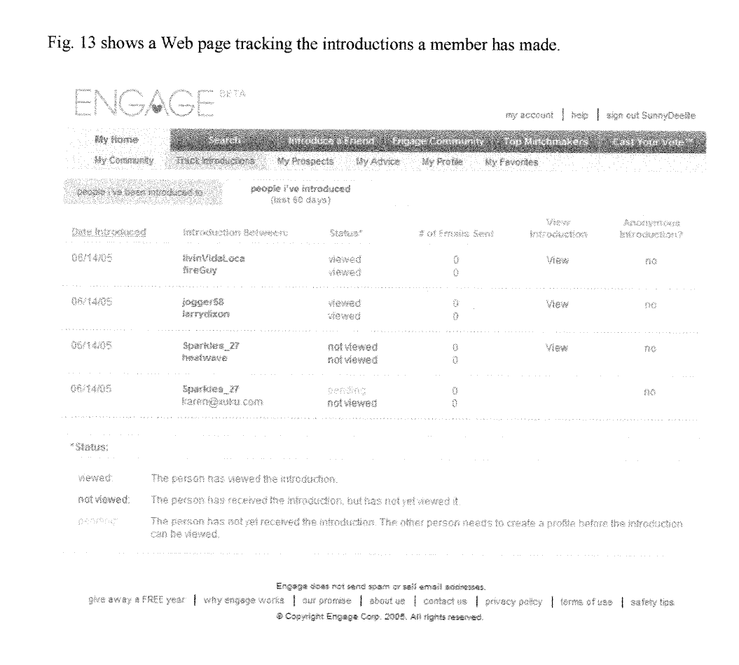

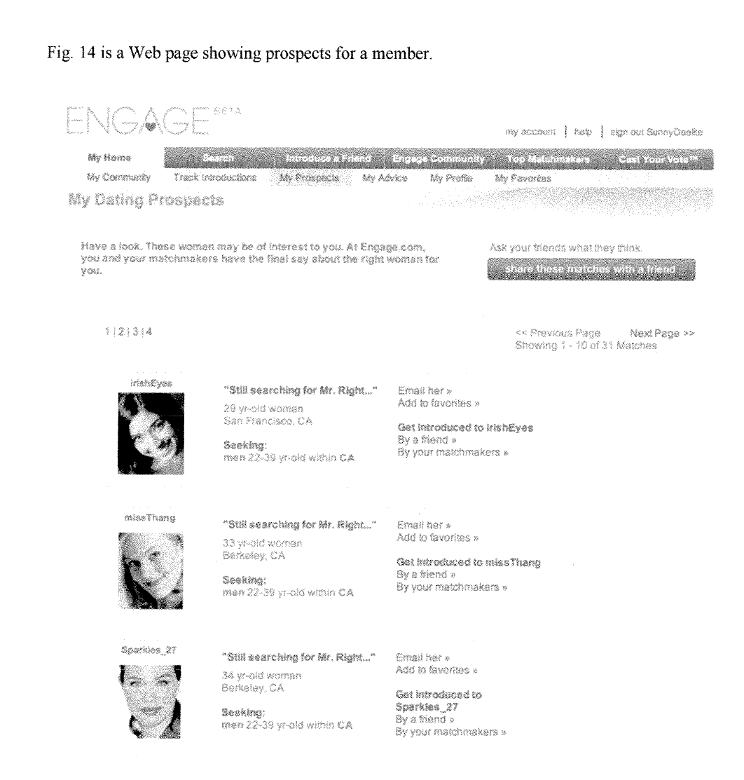

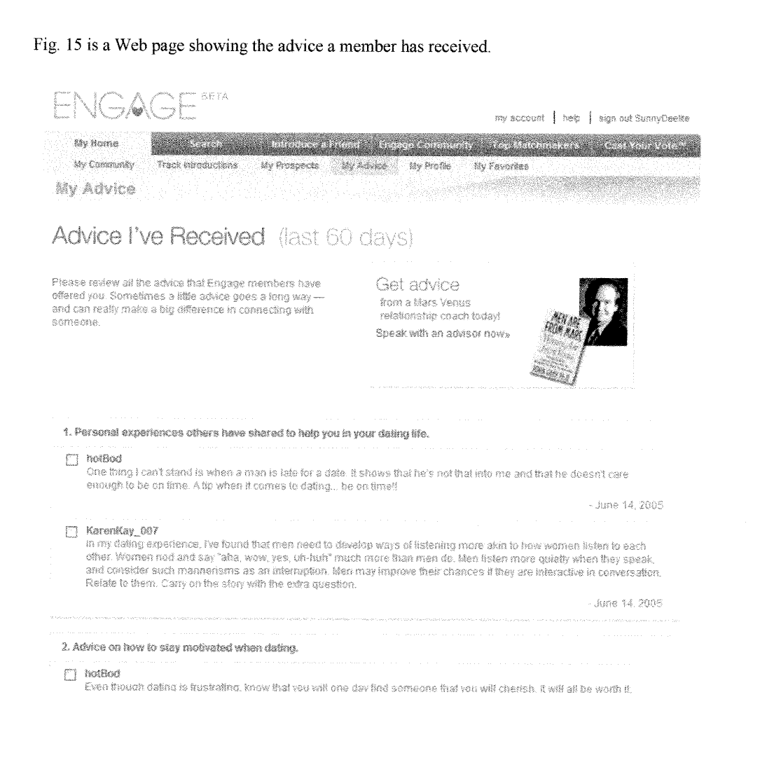

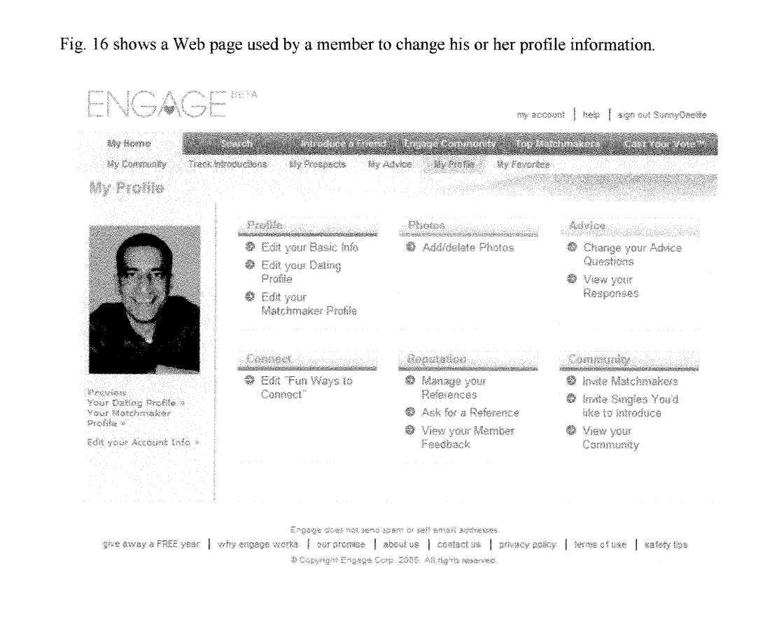

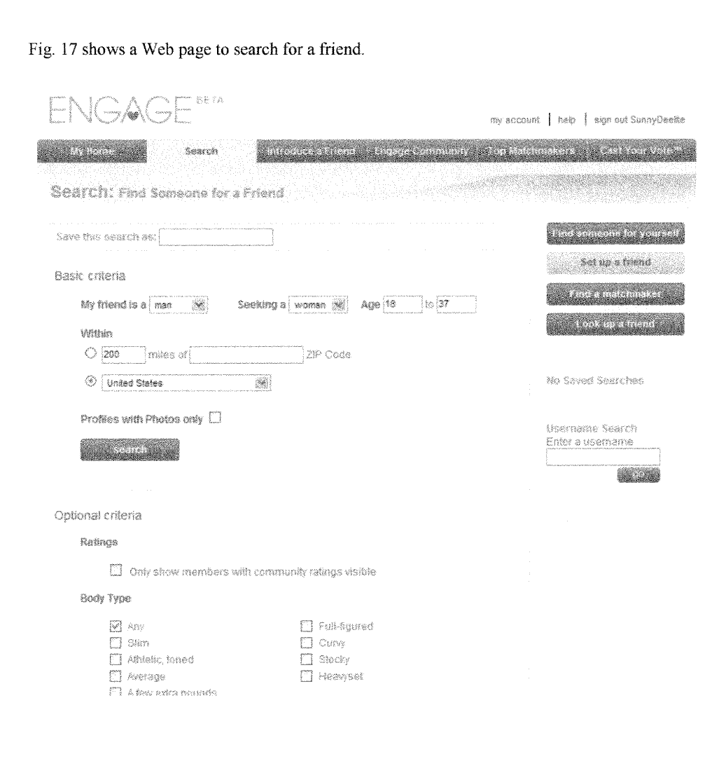

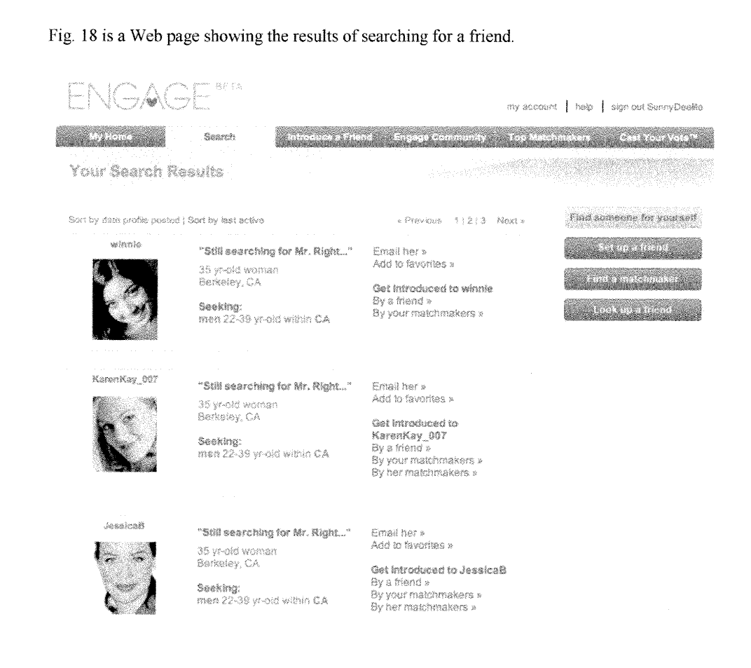

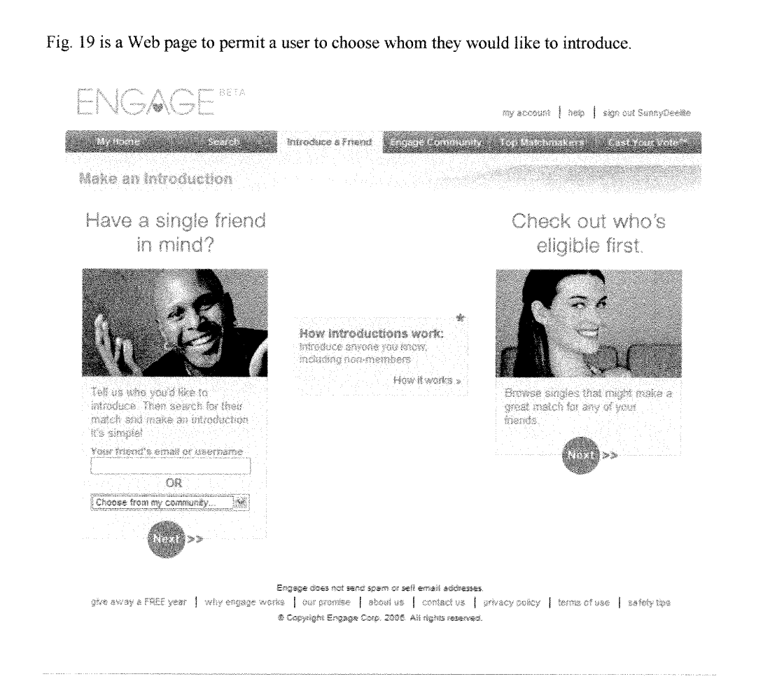

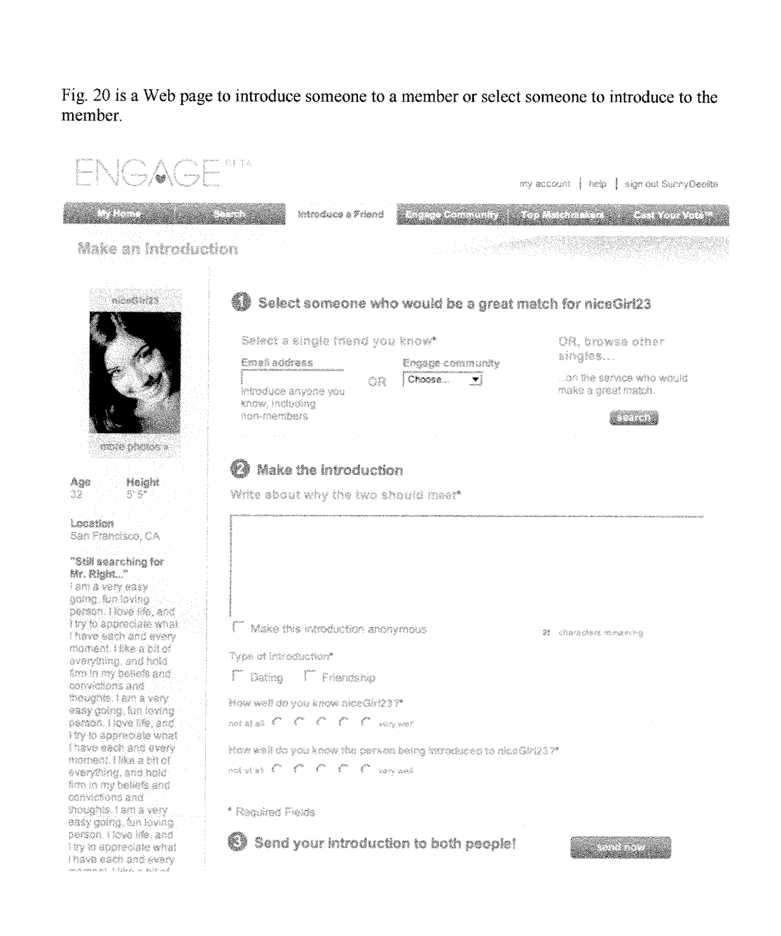

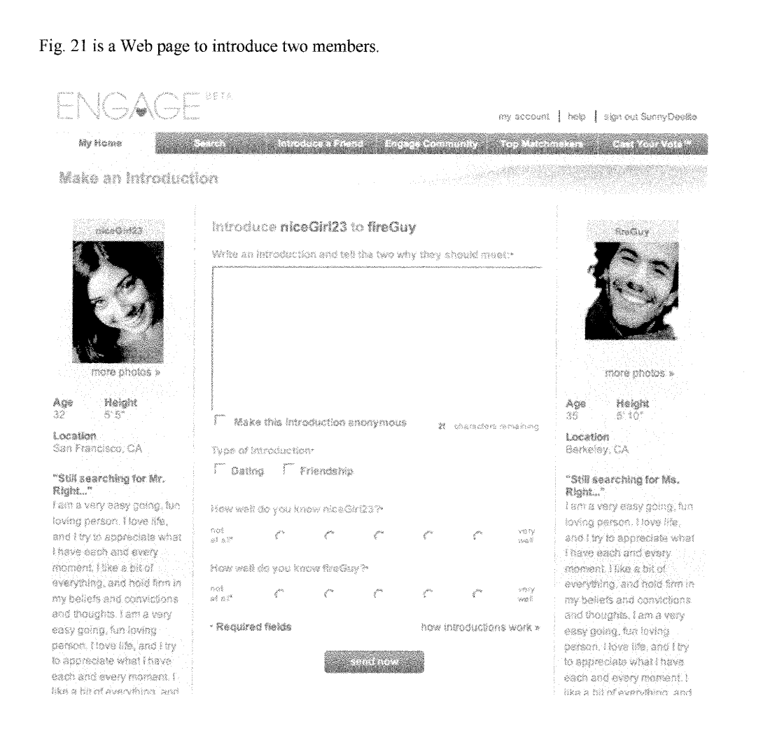

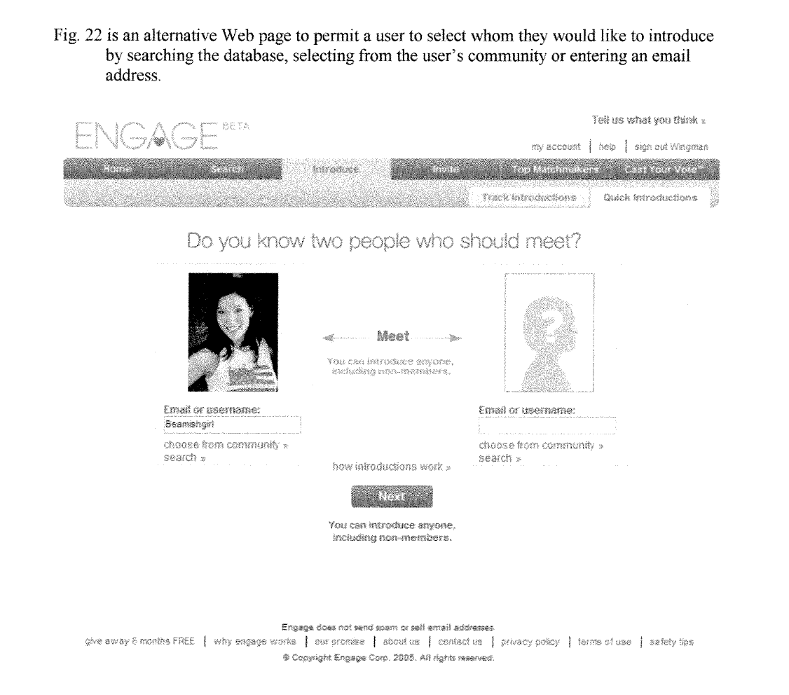

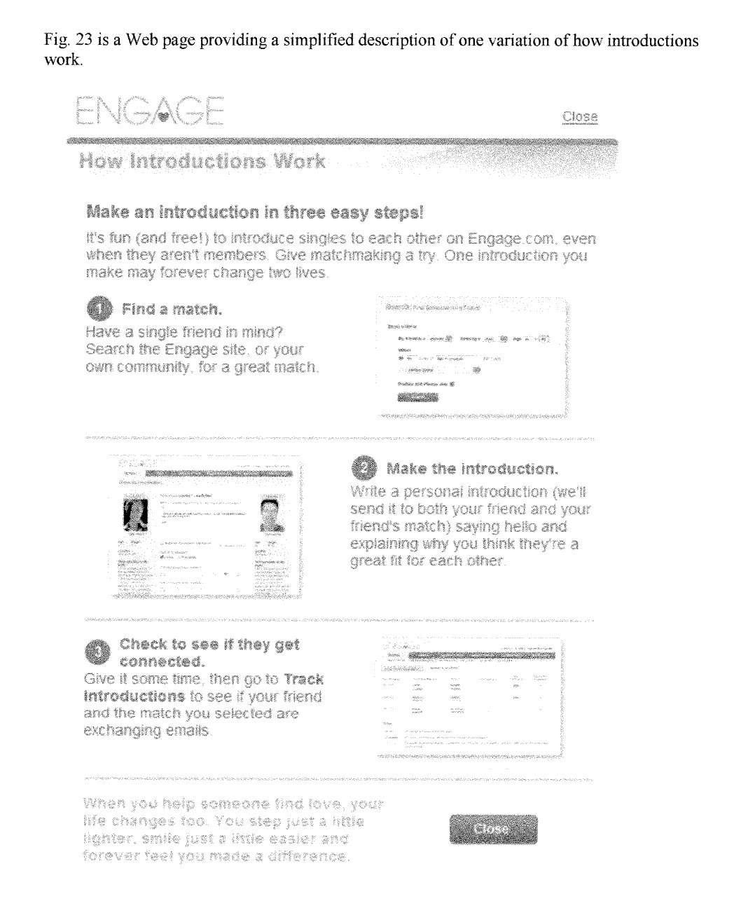

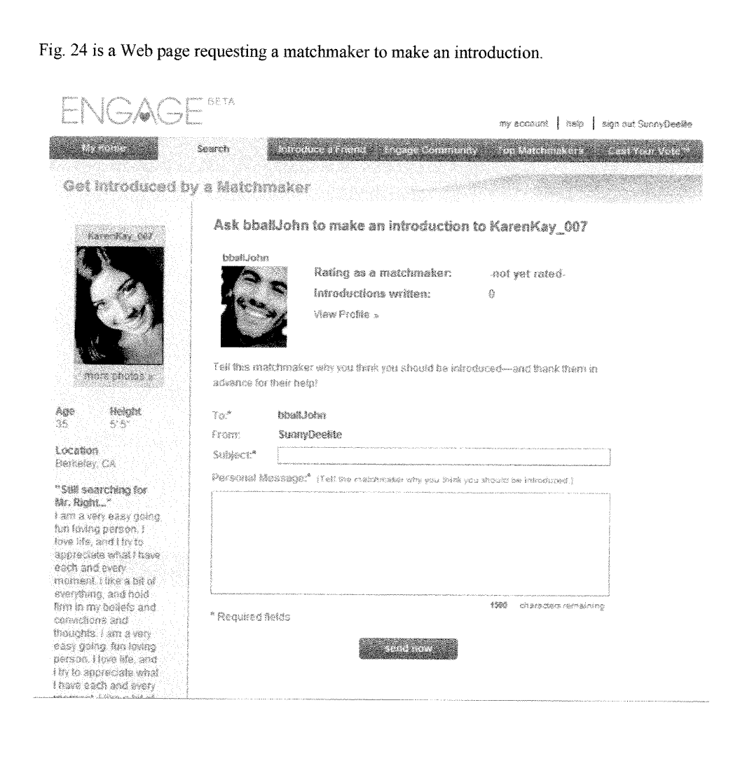

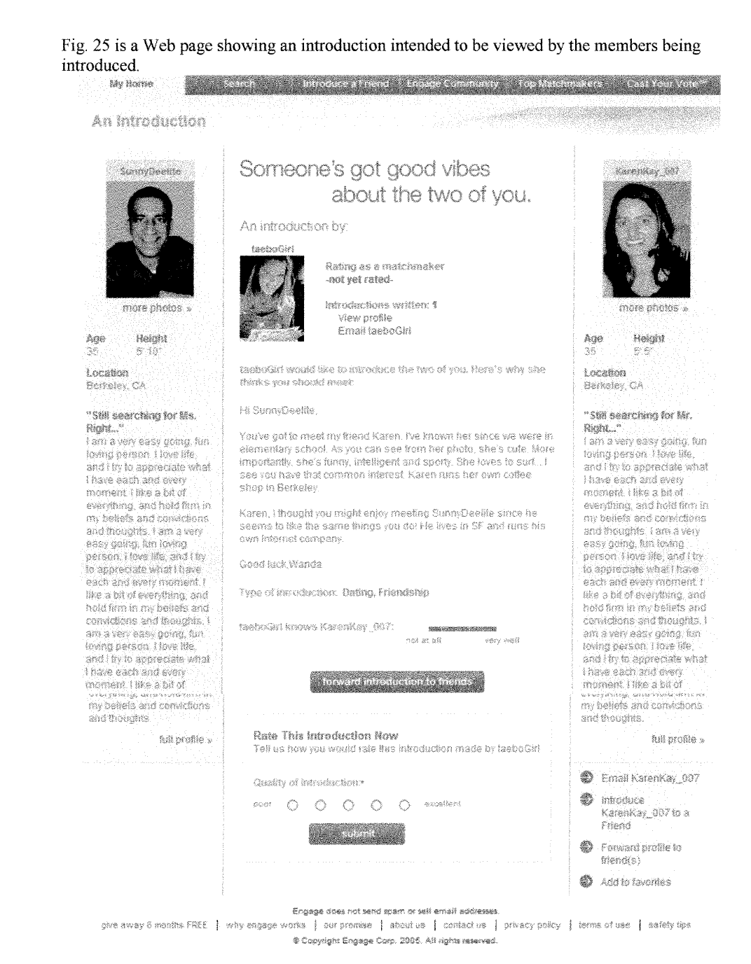

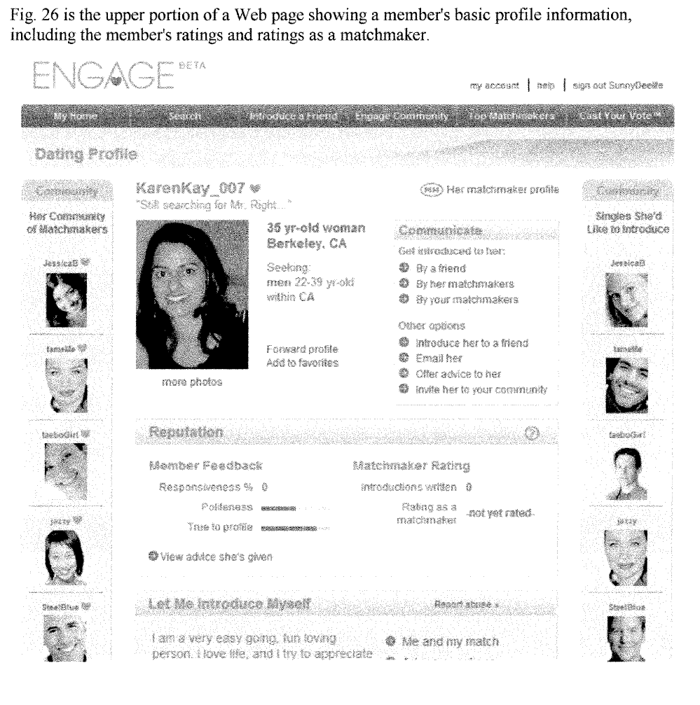

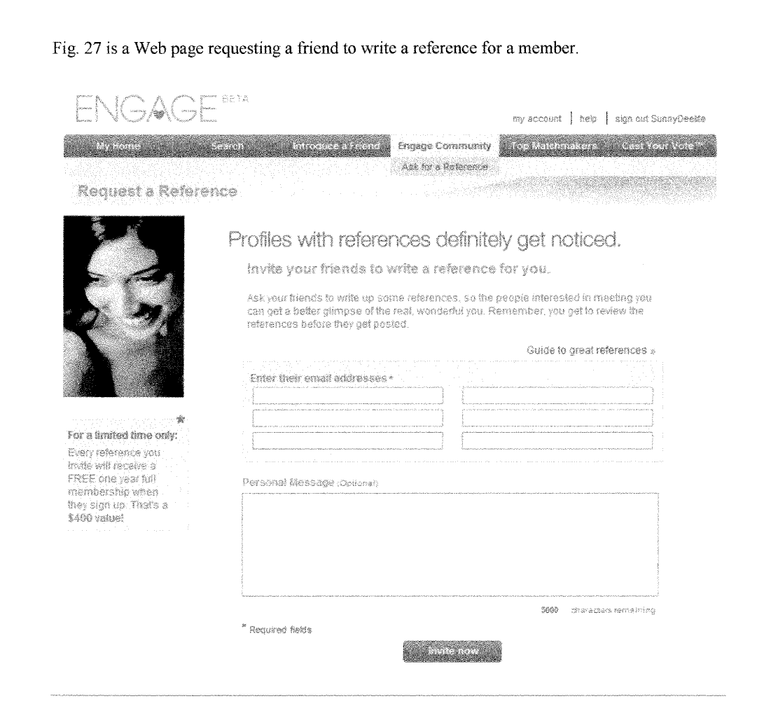

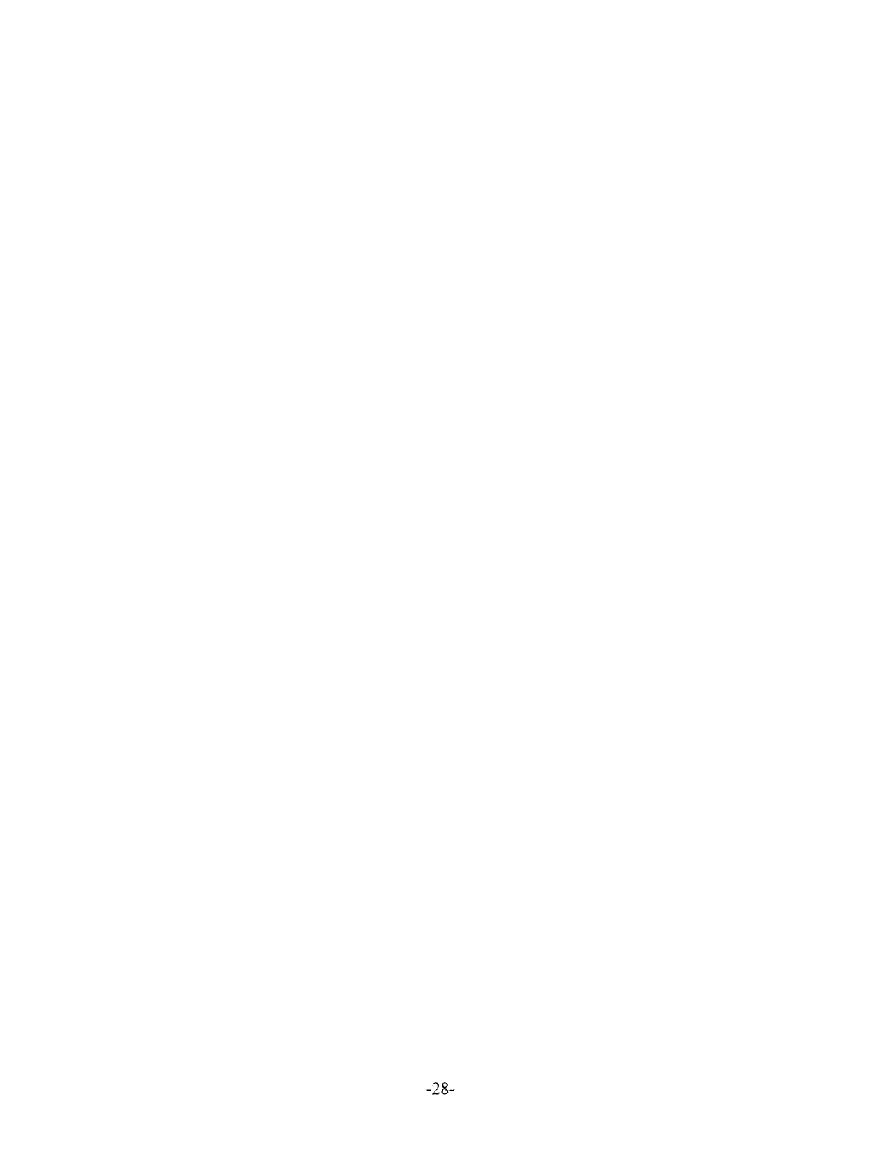

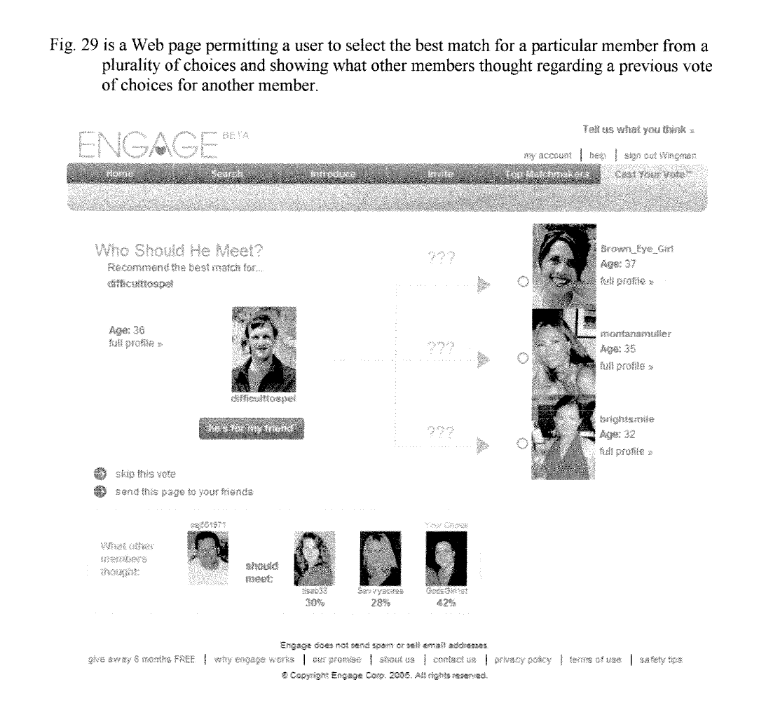

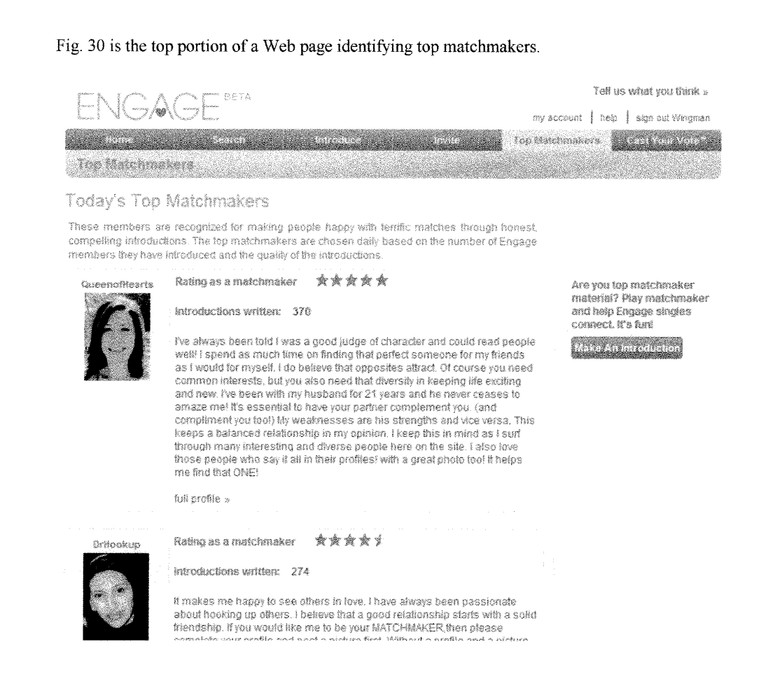

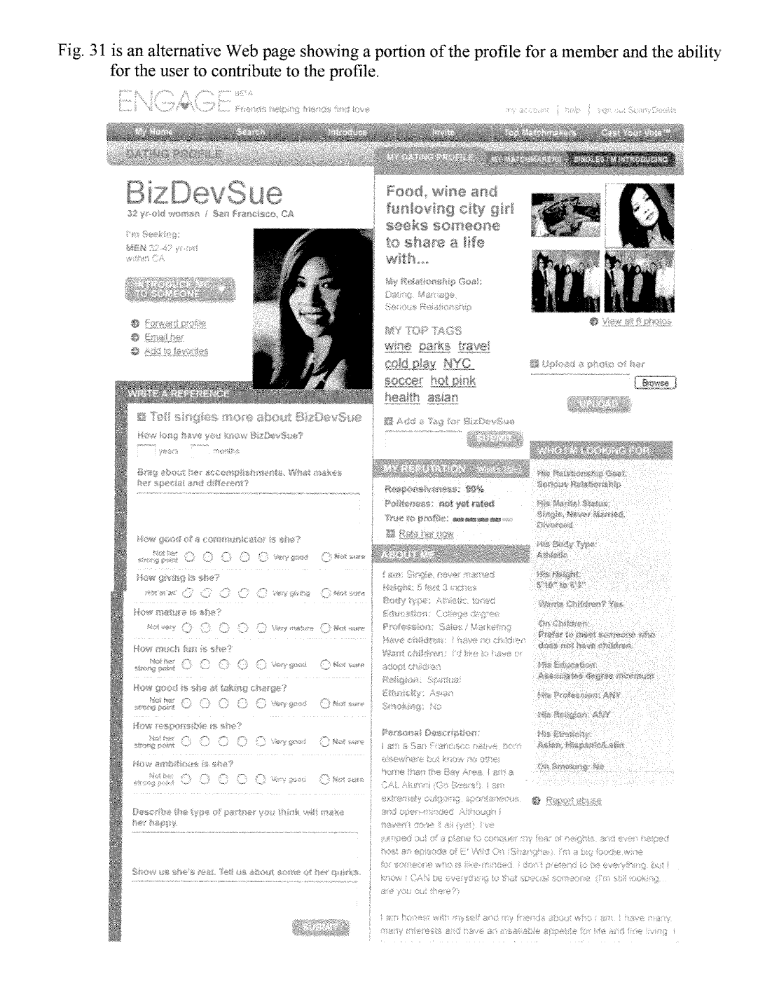

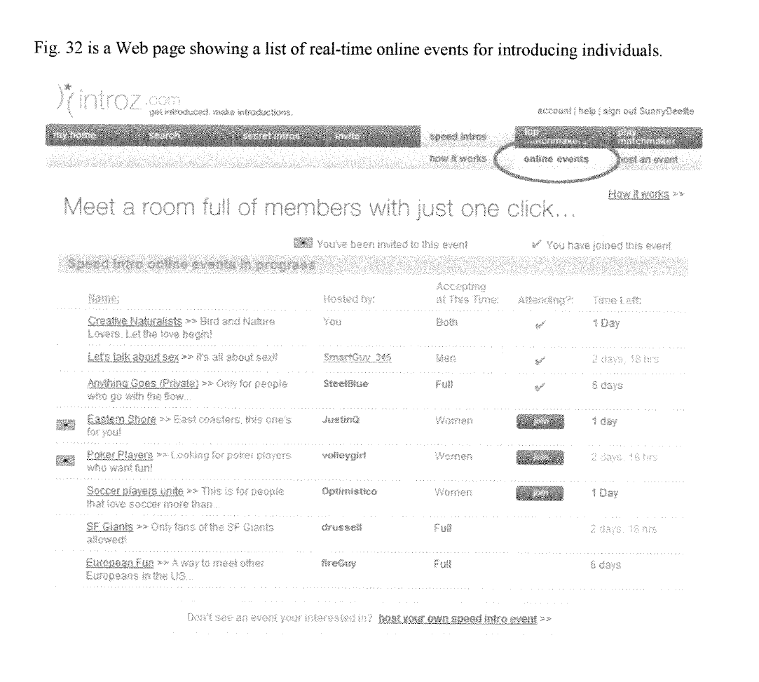

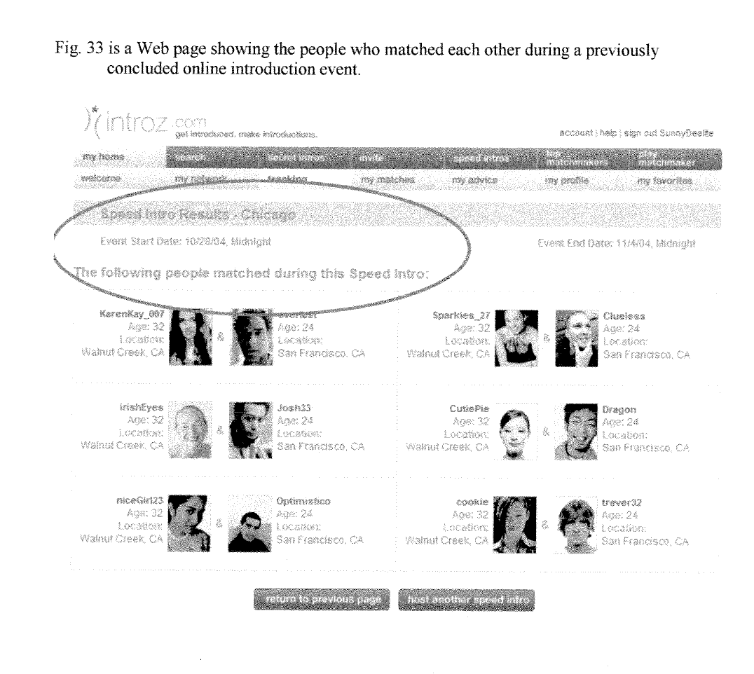

Members can invite non-members to join the service in a variety of ways (see FIGS. 7, 10, 19, 20, 22). Members can invite friends and acquaintances to be matchmakers for them. With respect to a specific individual that a member wants to meet, the member can invite a prospective or existing matchmaker to write an introduction for him or her. Members can also offer to sponsor a friend or acquaintance as a matchmaker for them. In addition, members can request individuals who are either current members or not to be a reference for them. References give background information about themselves and the members for whom they serve as reference so that other users will get a level of comfort that the member is reputable.

Another feature of the inventive system is a facility to create online events where multiple individuals can meet each other (see FIGS. 32, 33). A member of the service acts as a host, by specifying a title for the event, a beginning date and time and an ending date and time. The host also invites members and/or prospective members to participate in the event. Sometime during the prescribed time, each participant accesses the Web pages on the service displaying the event. The participant then selects which if any of the other participants he/she would like to meet. If two participants each identify the other as someone the participants would like to meet, the system will inform the participants of this result. As an incentive to become a host, the service may provide information to the host concerning which participants wanted to meet which other participants and perhaps additional related information such as whether the participants have communicated, and if so, how many times.

The real-time event could, for example, take place over several hours or several days. Participants would not have to be participating during the entire period of time, but could participate within the period when it is convenient for them. Multiple participants might, but do not have to, participate at the same time.

Among the many benefits of having matchmakers registered with the service, a user can quickly find out if there are already individuals interested in setting him or her up. A user can upload his or her electronic address book to see whether anyone in the address book is a matchmaker for someone else, in which case the user can invite the matchmaker to become a matchmaker for the user as well. Examples of electronic address books are AOL, Gmail, Hotmail, Yahoo, Outlook and Outlook Express.

The use of a user's address book to identify possible matchmakers can also be provided more transparently by automatically identifying individuals in a user's address book who could serve as a matchmaker. For example, when a user searches for members based on desired profile characteristics, the systems can highlight members who happen to have matchmakers in the user's address book. Then, the user could ask the matchmaker, who the user evidently already knows, to make an introduction.

Additional Features.

Additional aspects of the invention are embodied in features of the system that can be used either individually or collectively with other features. These additional aspects of the invention include the following:

Profile information that is gathered about each member on the service may be gender specific. The information is generally gathered during registration, but may alternatively be entered at a later time. Gathering gender specific profile information from the members enables the registration process for members of each gender to be streamlined without appreciably reducing the accuracy of the assessment of possible matches. Gathering gender specific information recognizes that members of different genders in general are interested in different characteristics in a potential mate.

The service also offers a feature that enables professional and amateur coaches to offer personal advice to members (e.g., peer-to-peer advice). See FIGS. 28, 15). The advice can be in the form of free-form text, responses to open-ended questions, or answers to multiple-choice questions. The advice could be rated and the coaches ranked, so that the service could provide a marketplace for romance or lifestyle coaches. Coaches with higher ratings and rankings could charge for their services, and the system could, in turn, charge the coaches or the members who use the coaches' services. Alternatively, the service could charge members fees for the services of the coaches and, in turn, pay the coaches a portion of the proceeds.

Although facilitating introductions of people by people is one aspect of the inventive system, the system itself can also introduce people automatically. The system could be configured to identify pairs of individuals with profiles that are sufficiently compatible. Once these pairs are identified, the system could send or provide an introduction to the individuals as opposed to a matchmaker initiating or sending the introduction.

Another aspect of the invention is that the system can serve as a general framework to present multiple Web services to different users. Each service would be oriented towards a separate socioeconomic or other niche group. Many individuals prefer to associate socially with other people having characteristics that are similar to themselves. So, the system could provide separate services for several different ethnic or age groups and groups of people with specific hobbies or interests. Each group would see only a subset of all members of the system, e.g. the members in their niche group.

Properly configured, the service can be used by gay and lesbian persons as effectively as for heterosexual individuals.

In addition to its use for dating and romantic purposes, the invention can be used for non-dating purposes as well. The invention can be applied to many situations in which individuals or entities are trying to be matched up with others and especially where a third party, such as a broker, can serve as an intermediary. In those situations, the service provides, among other things, a mechanism for an individual or entity to be introduced to another entity or individual. Example applications for the invention include matching jobs with employers, real estate sellers with buyers, and business sellers with buyers. In each of these cases the profile information gathered about each member would be different but again based on what characteristics others in the marketplace are interested in. The service provides a mechanism by which individuals who are looking for something can be helpful to others seeking similar things.

The invention can also be used in situations where more than two people are introduced at a time.

### IMPLEMENTATION EXAMPLE

The invention can be implemented using a variety of possible multi-user computer system architectures, the most popular of which is the World Wide Web (“Web”). FIG. 1 shows a block diagram of a Web-based application. The Web permits multiple users using Web browsers to retrieve information over the Internet. The Web browsers use a protocol such as Hyper Text Transfer Protocol (“HTTP”) to access the information from a Web server. Another protocol, such as the Uniform Resource Locator (“URL”) protocol, specifies which Web server is to be accessed and what information is to be retrieved. The resulting information is then returned from the Web server encoded in a way that can be displayed on a variety of devices. Two typical protocols for encoding presentation information on the Web are Hyper Text Markup Language (“HTML”) and Cascading Style Sheets (“CSS”).

In a multi-tiered architectural setup, the Web server is responsible for gathering information from the user and presenting the results back to the user using the aforementioned protocols. The Web server forwards logical operations regarding the particular application being used to an application server. The application server is responsible for analyzing business rules, logic and algorithms to decide what information needs to be presented by the Web server. The application server, in turn, can rely on a database for the storage, retrieval, maintenance and integrity of data.

Typical Web browsers are Firefox, Internet Explorer (IE), Netscape and Safari. Typical Web servers are Apache, the Netscape server and Internet Information Services (IIS). Typical Application Servers are WebSphere and BEA WebLogic. Typical databases are Oracle, MySQL, Postgres and SQL Server. These are examples of relational database management systems (RDBMS), as opposed to object oriented databases, which could also be used. All of these run on computers with operating systems such as Linux, Unix or Windows.

The examples of Web browsers, Web servers, application servers and databases given are intended to be illustrative only, as one skilled in the art would understand that there are alternative tools and methodologies for permitting multiple users to access a computerized application. For example, a so-called client-server model could be used. Also, the Web server and the application server could be combined. Furthermore, the system could be implemented in a peer-to-peer configuration where there is no centralized application, the system being implemented on the users' computers themselves.

Web servers and application servers usually rely on logic customized for an application in a programming language such as Java, C#, Perl, PHP and Active Server Pages (ASP).

Communication to members and others who are not currently accessing the Web site can be accomplished through an email system. The email system can use Simple Mail Transport Protocol (SMTP) or similar protocols to send email to the recipient. The email sent could either contain a complete message or it could request the recipient to access the service's Web site to read the complete contents of the message.

For fault tolerance and better performance, multiple Web servers, application servers and databases can be used simultaneously to provide the infrastructure for the system.

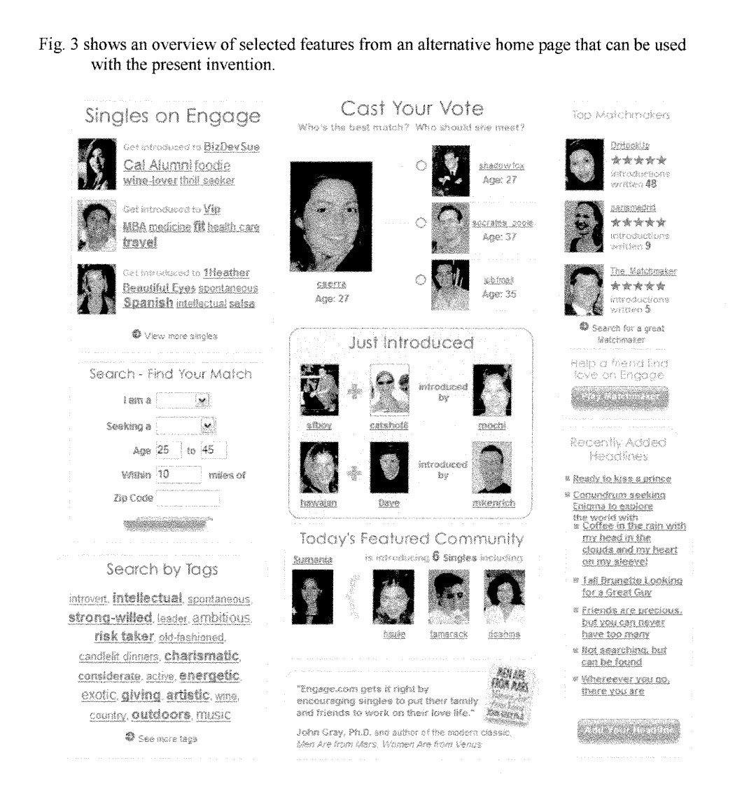

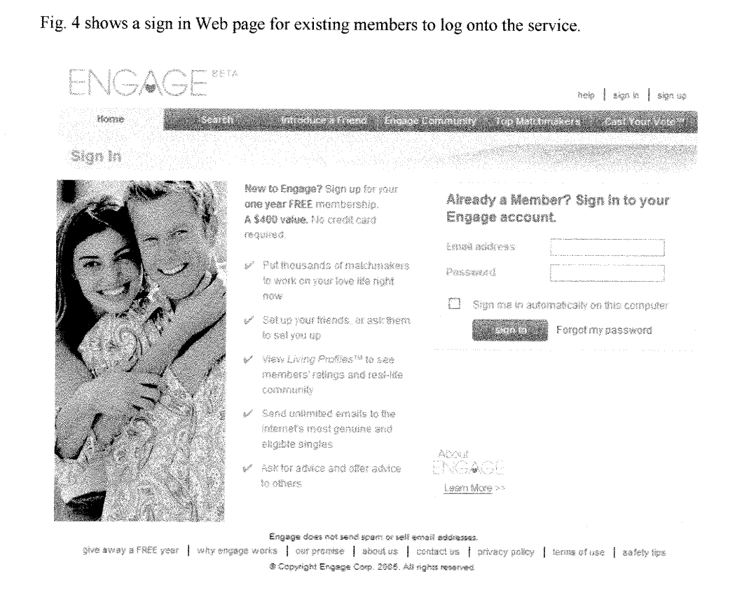

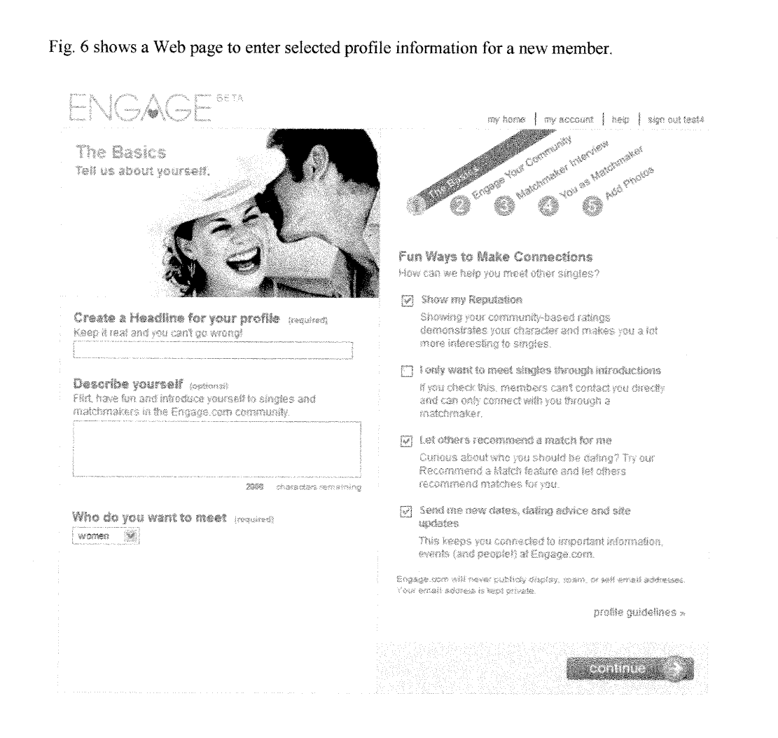

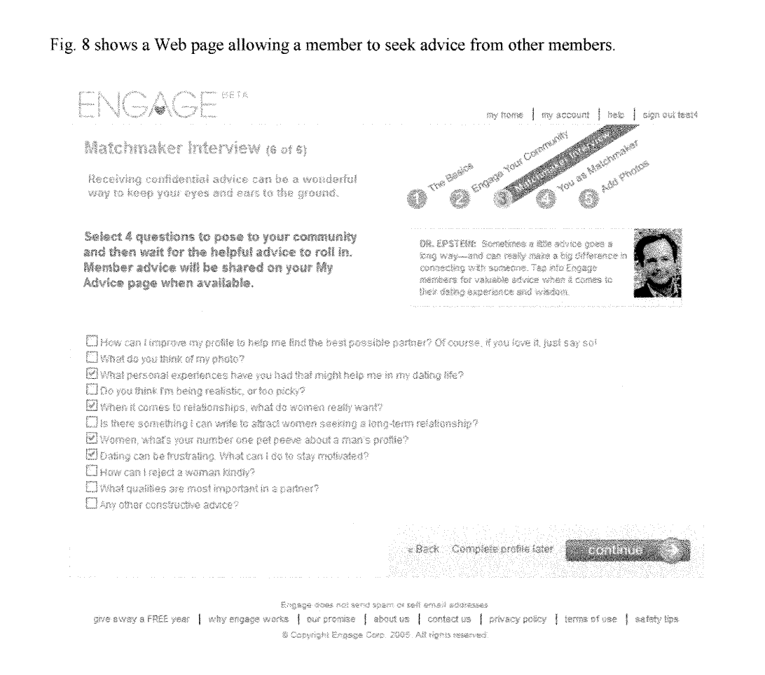

Those skilled in the art and familiar with the techniques of building Web-based applications would able to make and use the invention described in detail above and particularly illustrated in FIGS. 2-33, which are self-explanatory views of various web pages implementing the various features of the method and system of the invention as disclosed.

In particular, a system in accordance with a preferred embodiment of the invention would include at least one database residing on a server. The database stores information pertaining to participants, such as profile information, picture, audio or video information, e-mail information, etc. The database also would store similar information pertaining to intermediaries (e.g., matchmakers or brokers) as well as coaches. Additionally, the database could store ratings information and update the ratings information as new ratings/votes are entered into the system. The server contains applications that enable members to register, upload information, and communicate with other members, intermediaries or coaches. Additional applications are provided for enabling members to rate intermediaries and/or coaches, enabling online events to be hosted, and enabling members, intermediaries and/or coaches to search participant profiles stored on the database in accordance with at least one specified characteristic parameter.

In a typical scenario, an intermediary would search the database on behalf of a participant, and upon finding one or more potential matches, initiate an introduction of the participant to the identified potential match. Alternatively, the intermediary could be contacted by a participant regarding a specific potential match to whom the participant desires introduction. In this case, the intermediary could prepare an appropriate introduction, in essence “vouching” for the positive qualities of the participant.

One particular aspect of the invention is shown in FIG. 22. That is, while it is possible for an intermediary/matchmaker to search a database, according to the invention a matchmaker does not have to use a search feature to make an introduction. The matchmaker might already know the individuals being introduced, or the matchmaker might just stumble upon someone's username or email address while using the service. In such cases, the matchmaker could use a webpage as shown in FIG. 22 to introduce any two persons using only their respective user names (members) or email addresses (members or non-members).

Variation 1-Non-member to Non-member.

If a matchmaker is making an introduction from a non-member A to a non-member B the introduction text could just be sent to A and B with the reciprocal contact information, using the non-member's e-mail address.

Variation 1A-Invite Non-Members to Join First.

It may work better for the system to first invite the non-members to become members, then A and B become members by registering and thus indicating that they consent to being introduced to others, then A and B get to see the introduction text and send communications to each other.

Variation 1B-Pre-Approval.

Another variation is that one of A or B sees the introduction information first and decides whether the introduction should be sent to the other.

Variation 2-Member-to-Non-Member

An existing member may be introduced to a non-member by entering the member's username and the non-member's email address.

Variation 3-Non-Member-to-Member

A non-member may be introduced to an existing member by entering the non-member's email address and the member's username.

Variation 4-Member-to-Member

An existing member may be introduced to another member by entering each member's username.

Variation 2A-4A

When either A or B is a member, there is at least one less step than Variation 1A as the member does not have to be invited to register. The member could optionally be identified by the username.

In each of these scenarios, the communications system” may utilize a “blind” email system, in which neither party knows the actual email address of the other, but instead all emails are redirected through the system.

As discussed above, according to the invention it is also possible to provide a simulated intermediary, that may perform the same functions as a human intermediary, such as by searching the database on behalf of a particular participant based on information from the participant's personal profile and/or search parameters inputted by the participant. Additionally, such simulated intermediary may arrange for introductions of the participant to individuals or members identified by the participant to the intermediary as being of interest.

Having disclosed exemplary embodiments and the best mode, modifications and variations may be made to the disclosed embodiments while remaining within the subject and spirit of the invention as defined by the following claims. For example, the invention may be applied in many fields in addition to romance/lifestyle area, such as employment, business, real estate, sports, hobbies, culture, etc. Therefore, the present invention should be construed as limited only by the appended claims as properly construed. For example, each of the computer-executable applications set forth in the claims below can be a part of larger computer-executable applications, and does not have to be mutually exclusive of other computer-executable applications. Similarly, each of the databases set forth in the claims below can be a subset of a larger database, and does not have to be mutually exclusive of other databases in other implementations.

What is claimed is:

1. A computer-implemented system for introducing compatible individuals to each other, comprising:
a database storing information pertaining to individuals who are interested in being matched;
a computer-executable application that enables a first individual to search said database to identify a potentially compatible second individual;
a computer-executable application that enables said first individual to communicate identification of said potentially compatible second individual to an intermediary; and
a computer-executable application that enables said intermediary to introduce said first individual to said identified potentially compatible second individual.

2. The computer-implemented system of claim 1, wherein said introduction includes an indication of a level of familiarity of said intermediary with said first individual.

3. The computer-implemented system of claim 1, wherein said database includes a rating of said intermediary by users of said system.

4. The computer-implemented system of claim 1, wherein said first individual is a registered member of said system.

5. The computer-implemented system of claim 1, wherein said second individual is a registered member of said system.

6. The computer-implemented system of claim 1, wherein said intermediary is a registered member of said system.

7. The computer-implemented system of claim 6, wherein registered intermediaries may also be designated as individuals interested in being matched.

8. The computer-implemented system of claim 1, further including a computer-executable application for assembling said information, wherein said application contains separate information gathering processes for gathering information from male individuals and from female individuals.

9. The computer-implemented system of claim 1, wherein the identity of said intermediary is not revealed to said second individual.

10. A computer-implemented system for introducing compatible individuals to each other, comprising:
a database storing information pertaining to individuals who are interested in being matched;
a computer-executable application that enables an intermediary to search said database to identify a second individual who is potentially compatible with a first individual; and
a computer-executable application that enables said intermediary to introduce said first individual to said identified potentially compatible second individual.

11. The computer-implemented system of claim 10, wherein said introduction includes an indication of a level of familiarity of said intermediary with said first individual.

12. The computer-implemented system of claim 10, wherein said database includes a rating of said intermediary by users of said system.

13. The computer-implemented system of claim 10, wherein said first individual is a registered member of said system.

14. The computer-implemented system of claim 10, wherein said second individual is a registered member of said system.

15. The computer-implemented system of claim 10, wherein said intermediary is a registered member of said system.

16. The computer-implemented system of claim 15, wherein registered intermediaries may also be designated as individuals interested in being matched.

17. The computer-implemented system of claim 10, further including a computer-executable application for assembling said information, wherein said application contains separate information gathering processes for gathering information from male individuals and from female individuals.

18. A computer-implemented system for introducing compatible individuals to each other, comprising:
a database storing information pertaining to individuals who are interested in being matched;
a computer-executable application that enables first individuals to search said database to identify potentially compatible second individuals;
a computer-executable application that enables said first individuals to identify said potentially compatible second individuals to said system; and
a computer-executable application that enables said system to introduce first individuals to identified potentially compatible second individuals who also identified said first individuals to said system as being potentially compatible.

19. The computer-implemented system of claim 18, wherein said individuals search said database simultaneously during a real-time on-line event.

20. The computer-implemented system of claim 19, wherein specific individuals are invited to said real-time on-line event by an intermediary, and said search is limited to selection of individuals who have been invited to said event by said intermediary.

21. The computer-implemented system of claim 1, further including a computer-executable application that enables said first individual to identify a plurality of potentially compatible second individuals and to request a poll of other individuals to vote for specific ones of said identified potentially compatible second individuals to whom said first individual should be introduced.

22. The computer-implemented system of claim 10, further including a computer-executable application that enables said intermediary to identify a plurality of potentially compatible second individuals and to request a poll of other individuals to vote for specific ones of said identified potentially compatible second individuals to whom said first individual should be introduced.

23. The computer-implemented system of claim 18, further including a computer-executable application that enables said first individual to identify a plurality of potentially compatible second individuals and to request a poll of other individuals to vote for specific ones of said identified potentially compatible second individuals to whom said first individual should be introduced.

24. The computer-implemented system of claim 1, wherein said introduction is in the form of an electronic mail message containing a link to information about said first individual.

25. The computer-implemented system of claim 10, wherein said introduction is in the form of an electronic mail message containing a link to information about said first individual.

26. The computer-implemented system of claim 18, wherein said introduction is in the form of an electronic mail message containing a link to information about said first individual.

27. A computer-implemented method for introducing compatible individuals to each other, comprising the steps of:
enabling a first individual to search a database storing information pertaining to individuals who are interested in being matched to identify a potentially compatible second individual;
enabling said first individual to communicate identification of said potentially compatible second individual to an intermediary; and
enabling said intermediary to introduce said first individual to said identified potentially compatible second individual.

28. A computer-implemented method for introducing compatible individuals to each other, comprising the steps of:
enabling an intermediary to search a database storing information pertaining to individuals who are interested in being matched to identify a second individual who is potentially compatible with a first individual; and
enabling said intermediary to introduce said first individual to said identified potentially compatible second individual.

29. A computer-implemented method for introducing compatible individuals to each other, comprising the steps of:
enabling first individuals to search a database storing information pertaining to individuals who are interested in being matched to identify potentially compatible second individuals;
enabling said first individuals to identify said potentially compatible second individuals to an intermediary; and
enabling said intermediary to introduce first individuals to identified potentially compatible second individuals who also identified said first individuals to said intermediary as being potentially compatible.

30. A computer-implemented system for introducing compatible individuals to each other, comprising:
a database storing information pertaining to individuals who are interested in being matched;
a computer-executable application that enables a first individual to search said database to identify a potentially compatible second individual; and
a computer-executable application for assembling said information, wherein said application contains separate information gathering processes for gathering information from male individuals and from female individuals.

31. A computer-implemented system for introducing compatible individuals to each other, comprising:
a database storing information pertaining to individuals who are interested in being matched;
a computer-executable application that enables a first individual to search said database to identify a potentially compatible second individual; and
a computer-executable application that enables said first individual to identify a plurality of potentially compatible second individuals and to request a poll of other individuals to vote for specific ones of said identified potentially compatible second individuals to whom said first individual should be introduced.

32. A computer-implemented method for introducing compatible individuals to each other, comprising the steps of:
enabling an intermediary to enter into a communication service system information identifying individuals who are interested in being introduced to other potentially compatible individuals; and
using said communication system to introduce said individuals to each other.

33. The method of claim 32, wherein one of said individuals is a member of said communication service system and the other of said individuals is not a member.

34. The method of claim 33, wherein a username of said member is entered into said communication service system and an email address of said non-member is entered into said communication service system.

35. The method of claim 32, wherein both of said individuals are members of said communication service system.

36. The method of claim 35, wherein a username of each of said members is entered into said communication service system.

37. The method of claim 32, wherein neither of said individuals is a member of said communication service system.

38. The method of claim 37, wherein an email address of each of said non-members is entered into said communication service system.

39. The method of claim 32, further comprising the step of enabling the individuals being introduced to rate the quality of the introduction by the intermediary.

40. The method of claim 39, further comprising the steps of displaying the intermediaries with the highest ratings; and enabling users to contact displayed intermediaries.

41. A computer-implemented system for facilitating the introduction of compatible individuals to each other, comprising:
a database storing information pertaining to individuals who are interested in being matched to other individuals; and
a database storing, for at least one of such individuals, information pertaining to intermediaries who have agreed to introduce such individual to others.

42. The system of claim 41, further comprising:
a database storing, for at least one of such individuals, information pertaining to other individuals who are available to be introduced.

43. The system of claim 41, further comprising:
a computer-executable application to display at least a portion of the information pertaining to said intermediaries.

44. The system of claim 42, further comprising:
a computer-executable application to display at least a portion of the information pertaining to the intermediaries and the individuals who are available to be introduced.

45. A computer-implemented system for introducing compatible individuals to each other, comprising:
a database storing information pertaining to individuals who are interesting in being introduced to potentially compatible other individuals;
a computer-executable application that displays profile information about one of such individuals and a plurality of secondary individuals, and accepts input information whereby a user of the system can vote on which of the secondary individuals the first individual should meet; and
a storage medium for storing voting results for later display and/or communication.

46. The system of claim 45, wherein the user's vote represents the user's selection of the most compatible of the secondary individuals with the first individual.

47. The system of claim 45, wherein the user's vote represents the user's ranking of each of the secondary individuals based on compatibility with the first individual.

48. The system of claim 45, wherein the user's vote represents the user's assessment of the compatibility of each of the secondary individuals with the first individual.

49. A computer-implemented system for matching compatible individuals, comprising:
a database storing information pertaining to individuals who are interested in being matched with other potentially compatible individuals;
a computer-executable application that enables users to view at least a portion of such information with respect to a first individual; and
a computer-executable application that enables said users to add information about such first individual to said database.

50. The system of claim 49, further comprising:
a computer-executable application that enables said first individual to remove information added by a user that is undesired by said first individual.
